(19) United States
(12) Patent Application Publication
(10) Pub. No.: US 2013/0321640 A1
(43) Pub. Date: Dec. 5, 2013

(54) IMAGING DEVICE AND IMAGING METHOD

(71) Applicant: SONY CORPORATION, Tokyo (JP)

(72) Inventor: TATSUYA NAKATSUJI, Kanagawa (JP)

(73) Assignee: SONY CORPORATION, Tokyo (JP)

(21) Appl. No.: 13/875,629

(22) Filed: May 2, 2013

(30) Foreign Application Priority Data
May 31, 2012 (JP) 2012-123941

(51) Int. Cl. H04N 5/238

(52) U.S. Cl. CPC H04N 5/238
USPC 348/164; 348/217.1

(57) ABSTRACT

There is provided an imaging device including an image sensor that performs photoelectric conversion on subject light to generate an image signal, a photographing optical system that forms an image of the subject light on the image sensor, and a first optical member that transmits the subject light incident on the image sensor via the photographing optical system. The first optical member changes transmittance of a first band of the subject light according to an angle with respect to an optical axis of the photographing optical system.

### BACKGROUND

The present technology relates to an imaging device and an imaging method.

In recent years, demand for a function capable of performing imaging even in darkness such as at night has increased not only in small-size monitoring cameras for security and night-vision cameras mounted on vehicles but also in general cameras. Therefore, a camera device that includes an infrared cut filter and a dummy glass and is able to photograph a subject in the dark of night or the like by switching between the infrared cut filter and the dummy glass depending on cases in which the subject is bright and dark has been suggested (Japanese Unexamined Patent Application Publication No. 2005-318237).

### SUMMARY

However, since the camera device disclosed in Japanese Unexamined Patent Application Publication No. 2005-318237 has a configuration in which the infrared cut filter and the dummy glass are switched between in order to switch a transmissive band of light for use of nighttime photographing, a space is necessary to shelter the unused infrared cut filter or the unused dummy glass. Further, when a large-size image sensor such as an APSC is used, a large space should be ensured to shelter the infrared cut filter. Accordingly, in the configuration in which the infrared cut filter is sheltered, there is a problem that a camera may not be miniaturized since a sheltering space is ensured.

It is desirable to provide an imaging device and an imaging method capable of changing transmittance of a predetermined band of subject light without providing a space in which a filter or the like is sheltered.

According to a first embodiment of the present technology, there is provided an imaging device including an image sensor that performs photoelectric conversion on subject light to generate an image signal, a photographing optical system that forms an image of the subject light on the image sensor, and a first optical member that transmits the subject light incident on the image sensor via the photographing optical system. The first optical member may change transmittance of a first band of the subject light according to an angle with respect to an optical axis of the photographing optical system.

Further, according to a second embodiment of the present technology, there is provided an imaging method performed by an imaging device including an image sensor that performs photoelectric conversion on subject light to generate an image signal, a photographing optical system that forms an image of the subject light on the image sensor, and a first optical member that transmits the subject light incident on the image sensor via the photographing optical system, the method including changing transmittance of a first band of the subject light in the first optical member by changing an angle of the first optical member with respect to an optical axis of the subject light.

According to the embodiments of the present technology, it is possible to change transmittance of a predetermined band of subject light without providing a space to which an optical member such as a semi-transmissive film is sheltered.

### BRIEF DESCRIPTION OF THE DRAWINGS

FIG. 1A is a schematic sectional view illustrating an overall configuration of an imaging device in a first state according to a first embodiment;

FIG. 1B is a schematic sectional view illustrating an overall configuration of the imaging device in a second state according to the first embodiment;

FIG. 2A is a diagram illustrating transmittance of a semi-transmissive film;

FIG. 2B is a diagram illustrating the reflectance of the semi-transmissive film;

FIG. 3A is a diagram illustrating transmittance characteristics of the semi-transmissive film in the first state;

FIG. 3B is a diagram illustrating transmittance characteristics of an optical filter;

FIG. 3C is a diagram illustrating transmittance characteristics when the semi-transmissive film and the optical filter are combined;

FIG. 4A is a diagram illustrating transmittance characteristics of the semi-transmissive film in the second state;

FIG. 4B is a diagram illustrating transmittance characteristics of the optical filter;

FIG. 4C is a diagram illustrating transmittance characteristics when the semi-transmissive film and the optical filter are combined;

FIG. 5A is a schematic sectional view illustrating an overall configuration of an imaging device in a third state according to a second embodiment;

FIG. 5B is a schematic sectional view illustrating an overall configuration of the imaging device in a fourth state according to the second embodiment;

FIG. 6A is a diagram illustrating transmittance characteristics of the semi-transmissive film in the third state;

FIG. 6B is a diagram illustrating transmittance characteristics of an optical filter;

FIG. 6C is a diagram illustrating transmittance characteristics when the semi-transmissive film and the optical filter are combined;

FIG. 7A is a diagram illustrating transmittance characteristics of the semi-transmissive film in the fourth state;

FIG. 7B is a diagram illustrating transmittance characteristics of the optical filter;

FIG. 7C is a diagram illustrating transmittance characteristics when the semi-transmissive film and the optical filter are combined;

FIG. 8A is a schematic sectional view illustrating an overall configuration of an imaging device in a fifth state according to a third embodiment;

FIG. 8B is a schematic sectional view illustrating an overall configuration of the imaging device in a sixth state according to the third embodiment;

FIG. 9A is a diagram illustrating transmittance characteristics of a first semi-transmissive film in the fifth state;

FIG. 9B is a diagram illustrating transmittance characteristics of a second semi-transmissive film;

FIG. 9C is a diagram illustrating transmittance characteristics of an optical filter;

FIG. 9D is a diagram illustrating transmittance characteristics when the first semi-transmissive film, the second semi-transmissive film, and the optical filter are combined;

FIG. 10A is a diagram illustrating transmittance characteristics of the first semi-transmissive film in the sixth state;

FIG. 10B is a diagram illustrating transmittance characteristics of the second semi-transmissive film;

FIG. 10C is a diagram illustrating transmittance characteristics of the optical filter; and

FIG. 10D is a diagram illustrating transmittance characteristics when the first semi-transmissive film, the second semi-transmissive film, and the optical filter are combined.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments of the present technology will be described with reference to the drawings. The description thereof will be made in the following order:

### <1. First Embodiment>

### [1-1. Configuration of Imaging Device]

### [1-2. Operation and Advantage of Imaging Device]

### <2. Second Embodiment>

### [2-1. Configuration of Imaging Device]

### [2-2. Operation and Advantage of Imaging Device]

### <3. Third Embodiment>

### [3-1. Configuration of Imaging Device]

### [3-2. Operation and Advantage of Imaging Device]

### <4. Modification Example>

### 1. First Embodiment

### 1-1. Configuration of Imaging Device

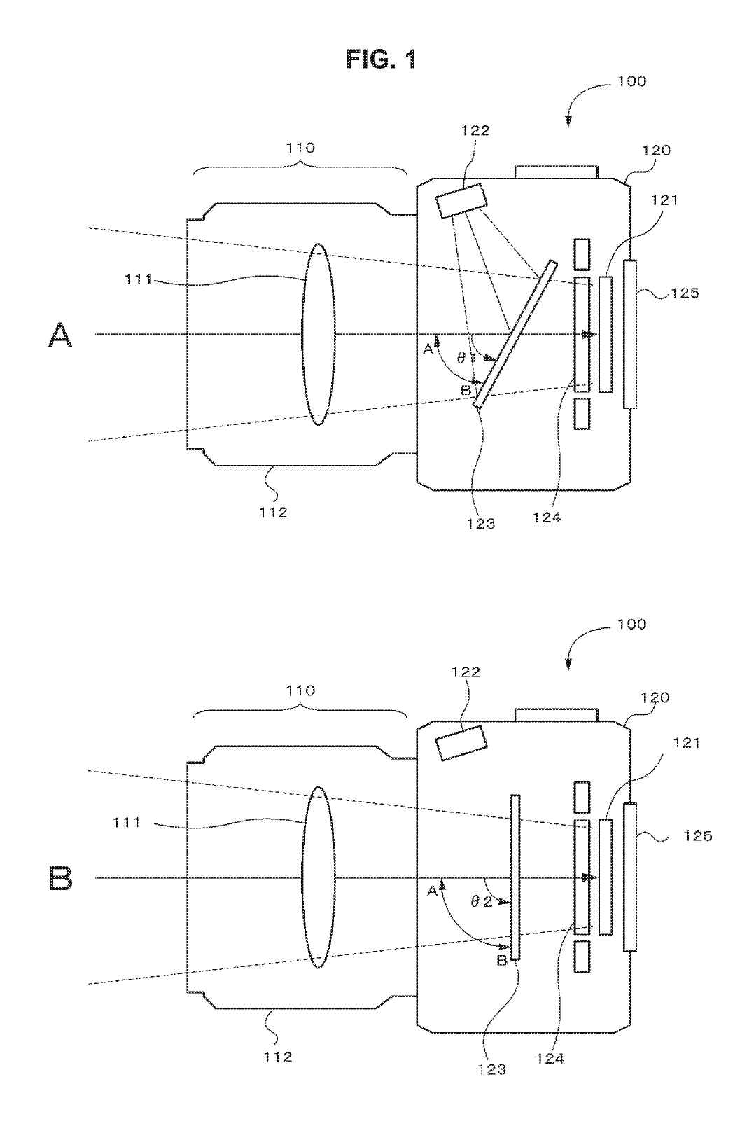

FIGS. 1A and 1B are schematic sectional views illustrating an overall configuration of an imaging device 100 according to a first embodiment of the present technology. As illustrated in FIGS. 1A and 1B, an exchangeable photographing optical system 110 is mounted on a casing 120 that forms a body of the imaging device 100. The photographing optical system 110 is configured by installing a photographing lens 111, a diaphragm, or the like inside a lens tube 112. The photographing lens 111 of the photographing optical system 110 is driven by a focus driving system (not illustrated) so that an AF operation is enabled. Further, the photographing optical system 110 may be integrated with the casing 120.

An image sensor 121 is installed inside the casing 120. The image sensor 121 is, for example, an imaging element such as a charge coupled device (CCD) or a complementary metal oxide semiconductor (CMOS). The image sensor 121 performs photoelectric conversion on subject light incident via the photographing lens 111 to convert the subject light into a charge amount and generates an image signal. The image signal is subjected to predetermined signal processing such as a correlated double sampling (CDS) process, a white balance adjustment process, and a gamma correction process and is stored finally as image data in a memory (not illustrated) inside the imaging device 100, an external memory, or the like. In FIG. 1, a shutter mechanism is not illustrated, but both a mechanical shutter and an electronic shutter can be applied in the embodiment of the present technology.

An AF sensor 122 which is an AF image sensor is also installed inside the casing 120. For example, the AF sensor 122 of a phase-difference detection type is used as the AF sensor 122. However, the embodiment of the present technology is not limited to the phase difference detection type, but a function of the AF sensor 122 of a contrast AF type may be provided. The phase difference detection type and the contrast AF type may be combined as an AF type. To perform AF satisfactorily even in a dark place or for a subject with low contrast, AF auxiliary light may be generated and an AF evaluation value may be obtained from returned light.

Inside the casing 120, a semi-transmissive film 123 is disposed between the photographing lens 111 of the photographing optical system 110 and the image sensor 121 inside the casing 120. The subject light is incident on the semi-transmissive film 123 via the photographing lens 111. The semi-transmissive film 123 reflects a part of the subject light incident via the photographing lens 111 from the AF sensor 122 and transmits the remaining light to the image sensor 121.

The semi-transmissive film 123 is configured to be rotatably driven in an AB direction so that an angle θ with respect to an optical axis of the photographing lens 111 can be changed. The change in the angle θ by the rotation of the semi-transmissive film 123 is performed, for example, when a driving mechanism that drives the semi-transmissive film 123 operates according to a user's input to the imaging device 100 under the control of a control unit or the like of the imaging device 100 controlling all or each of the units.

The semi-transmissive film 123 has different spectral transmittance characteristics between a case (hereinafter referred to as a first state) of “θ=θ1” illustrated in FIG. 1A and a case (hereinafter referred to as a second state) of “θ=θ2” illustrated in FIG. 1B. A film configuration in which the spectral transmittance characteristics are changed according to the angle with respect to the optical axis of the photographing lens 111 is assumed to be formed on the semi-transmissive film 123 by deposition and sputtering film formation or the like. The detailed spectral transmittance characteristics of the semi-transmissive film 123 will be described below. Further, θ1 and θ2 are assumed to satisfy a relation of “θ1<θ2.” More preferably, θ1 and θ2 are assumed to satisfy a relation of “θ1<θ2<90°.”

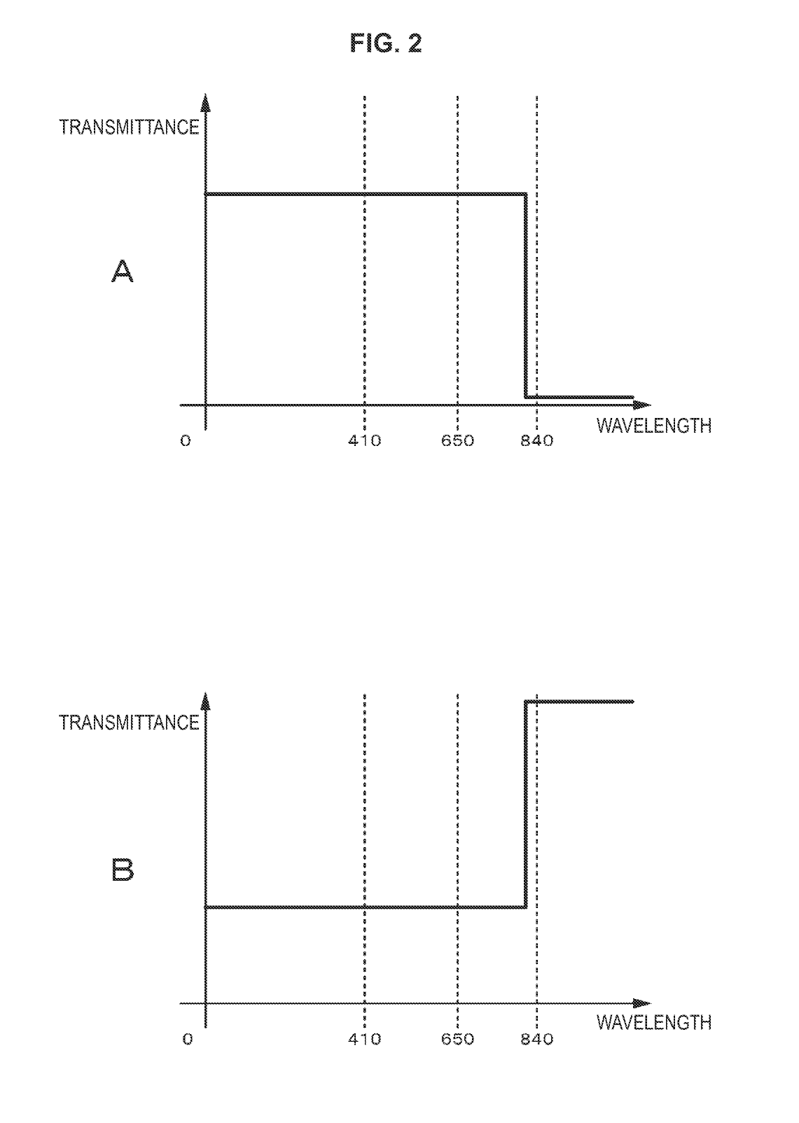

The transmittance of the semi-transmissive film 123 in the first state illustrated in FIG. 1A is illustrated in FIG. 2A. FIG. 2A is a diagram illustrating the transmittance of the semi-transmissive film in the first state. The vertical axis represents the transmittance and the horizontal axis represents a wavelength. The subject light transmitted through the semi-transmissive film 123 is incident on the image sensor 121 via the optical filter 124. The reflectance of the semi-transmissive film 123 in the state illustrated in FIG. 1A is illustrated in FIG. 2B. FIG. 2B is a diagram illustrating the reflectance of the semi-transmissive film in the first state. The vertical axis represents the reflectance and the horizontal axis represents a wavelength. The subject light reflected from the semi-transmissive film 123 is incident on the AF sensor 122.

In FIGS. 1A and 1B, dashed lines indicate light flux of the subject light incident on the image sensor 121 and one-dot chain lines indicate light flux of the subject light reflected from the semi-transmissive film and incident on the AF sensor 122.

The optical filter 124 is disposed between the semi-transmissive film 123 and the image sensor 121. The optical filter 124 is configured to have predetermined spectral transmittance characteristics as an embodiment. The detailed spectral transmittance characteristics of the optical filter 124 will be described below.

A display 125 that has a function of an electronic viewfinder is installed in the casing 120 of the imaging device 100. A flat display such as a liquid crystal display (LCD) or an organic electroluminescence (EL) display is used as the display 125. The image data obtained when a signal processing unit (not illustrated) processes an image signal extracted from the image sensor 121 or the AF sensor 122 is supplied to the display 125, and a current subject image (moving image) is displayed on the display 125. In FIGS. 1A and 1B, the display 125 is installed on the rear surface of the casing, but the embodiment of the present technology is not limited thereto. The display 125 may be installed on the upper surface or the like of the casing or may be a movable type display or a detachable type display.

The imaging device 100 has the above-described configuration.

### 1-2. Operation and Advantage of Imaging Device

Next, an operation and an advantage of the imaging device 100 having the above-described configuration will be described. By rotatably driving the semi-transmissive film 123 in the AB direction, the angle θ with respect to the optical axis of the photographing lens 111 can be changed from θ1 to θ2.

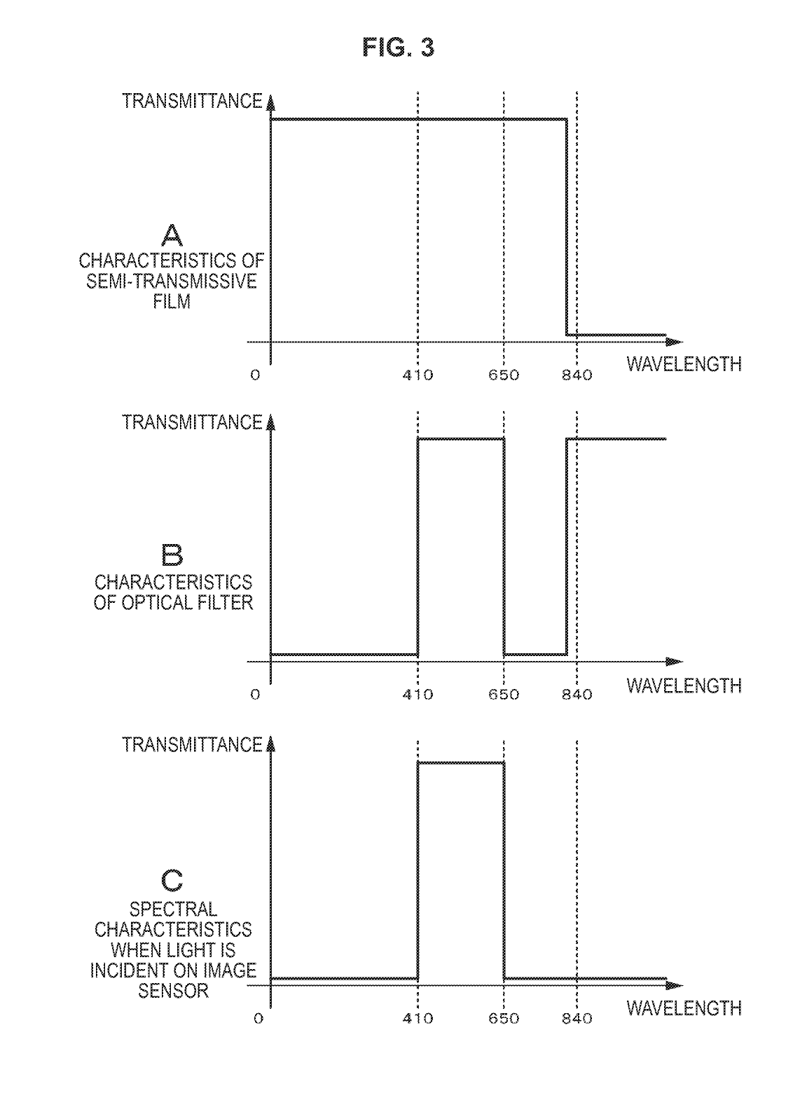

FIGS. 3A to 3C are diagrams illustrating spectral transmittance characteristics of the optical filter 124 and the semi-transmissive film 123 in the first state (θ=θ1) illustrated in FIG. 1A. The vertical axis represents transmittance and the horizontal axis represents a wavelength. The spectral transmittance characteristics of the semi-transmissive film 123 are shown in a form normalized according to the spectral transmittance characteristics of the optical filter 124.

FIG. 3A illustrates the spectral transmittance characteristics of the semi-transmissive film 123. A cut wavelength of the semi-transmissive film 123 in the first state is 825 nm. A band equal to or less than 825 nm of the subject light is transmitted and a band equal to or greater than 825 nm of the subject light is not transmitted.

FIG. 3B illustrates the spectral transmittance characteristics of the optical filter 124. According to the spectral transmittance characteristics of the optical filter 124, a band equal to or less than 410 nm is not transmitted, a band of 410 nm to 650 nm of the visible light is transmitted, a band of 650 nm to 830 nm is not transmitted, and a band equal to or greater than 830 nm is transmitted.

FIG. 3C illustrates the spectral transmittance characteristics when the semi-transmissive film 123 in the first state and the optical filter 124 are combined. Since both the semi-transmissive film 123 and the optical filter 124 transmit the band of 410 nm to 650 nm of the visible light, the band of 410 nm to 650 nm of the subject light is incident on the image sensor 121.

On the other hand, the band equal to or greater than 825 nm which is the cut wavelength of the semi-transmissive film 123 is transmitted through the optical filter 124, but is not transmitted through the semi-transmissive film 123. Accordingly, the band equal to or greater than 825 nm of the subject light is not transmitted through the semi-transmissive film 123 and is thus not incident on the image sensor 121 when the semi-transmissive film 123 and the optical filter 124 are combined. Accordingly, only the band of 410 nm to 650 nm of the visible light is incident on the image sensor 121, and the other bands of the subject light is not incident on the image sensor 121.

Thus, color reproduction can be easily designed, and an image with high quality can be photographed and generated. For example, by causing a band of a high wavelength which is an unnecessary band of the subject light not to be incident on the image sensor 121 in daytime photographing, high quality of an image acquired through the daytime photographing can be achieved.

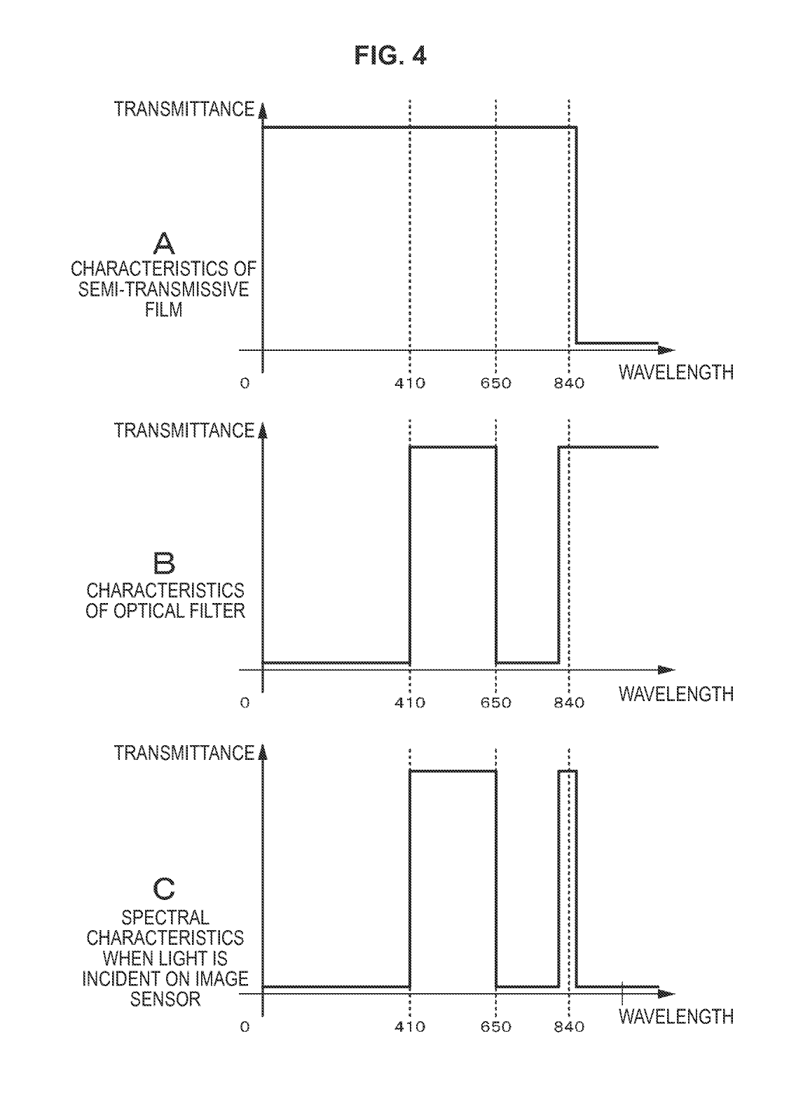

FIGS. 4A to 4C are diagrams illustrating spectral transmittance characteristics of the semi-transmissive film 123 and the optical filter 124 in the second state (θ=θ2) illustrated in FIG. 1B. The vertical axis represents transmittance and the horizontal axis represents a wavelength. As described above, θ1 and θ2 are assumed to satisfy the relation of “θ1<θ2.” More preferably, θ1 and θ2 are assumed to satisfy the relation of “θ1<θ2<90°.”

FIG. 4A illustrates spectral transmittance characteristics of the semi-transmissive film 123. According to the spectral transmittance characteristics of the semi-transmissive film 123 in the second state, the cut wavelength is 850 nm, a band equal to or less than 850 nm is transmitted and a band equal to or greater than 850 nm is not transmitted.

Since the relation of “θ1<θ2” is satisfied, the incident angle of the subject light on the semi-transmissive film 123 is smaller in a case of “θ=θ2,” and thus a difference of a light path length in an optical thin film on the semi-transmissive film 123 is longer, compared to a case of “θ=θ1.” Therefore, the cut wavelength is shifted toward the long wavelength side, and thus becomes 850 nm from 825 nm. Thus, the semi-transmissive film 123 transmits the band equal to or less than 850 nm of the subject light.

Since the optical filter 124 is not changed between the first and second states, the spectral transmittance characteristics of the optical filter 124 are not changed. The spectral transmittance characteristics of the optical filter 124 illustrated in FIG. 4B are the same as those illustrated in FIG. 3B.

FIG. 4C illustrates the spectral transmittance characteristics when the semi-transmissive film 123 in the second state and the optical filter 124 are combined. The subject light of the band of 410 nm to 650 nm of the visible light is transmitted through the semi-transmissive film 123 and the optical filter 124, and then is incident on the image sensor 121. This state is the same as the first state.

Since the cut wavelength of the semi-transmissive film 123 is also shifted up to 850 nm in the second state, the band equal to or less than 850 nm of the subject light is transmitted through the semi-transmissive film 123. On the other hand, since the optical filter 124 transmits the subject light of the band equal to or greater than 830 nm, as illustrated in FIG. 4C, the band of 830 nm to 850 nm is also transmitted through the semi-transmissive film 123 and the optical filter 124, and then is incident on the image sensor 121.

That is, in the second state, not only the band of 410 nm 650 nm of the visible light but also the band of 830 nm to 850 nm in the subject light is transmitted through the image sensor 121. Accordingly, when a light-emitting element that emits infrared light of the band of 830 nm to 850 nm is used to perform photographing, nighttime photographing can be performed. A band with wavelengths higher than the band of the visible light corresponds to a second band in an embodiment of the present technology.

By setting the band incident on the image sensor 121 to the band of the infrared light only in the second state, the first state can be used for normal photographing and the second state can be used for nighttime photographing. According to the embodiment of the present technology, for example, an operation of sheltering the semi-transmissive film 123 is not necessary. By changing only the angle of the semi-transmissive film 123, the nighttime photographing can be performed with high accuracy.

By changing the angle of the semi-transmissive film, the transmittance of the infrared light can be changed. Therefore, in the daytime photographing, quality of an image can be improved, compared to an imaging device that includes an optical filter with spectral characteristics in which the infrared light can be received in advance.

For example, the first state may be set to a normal photographing mode and the second state may be set to a nighttime photographing mode in the imaging device 100. Then, by rotatably driving the semi-transmissive film 123 according to a user's input of mode switching of the imaging device 100, the first and second states may be switched.

### 2. Second Embodiment

### 2-1. Configuration of Imaging Device

Next, a second embodiment of the present technology will be described.

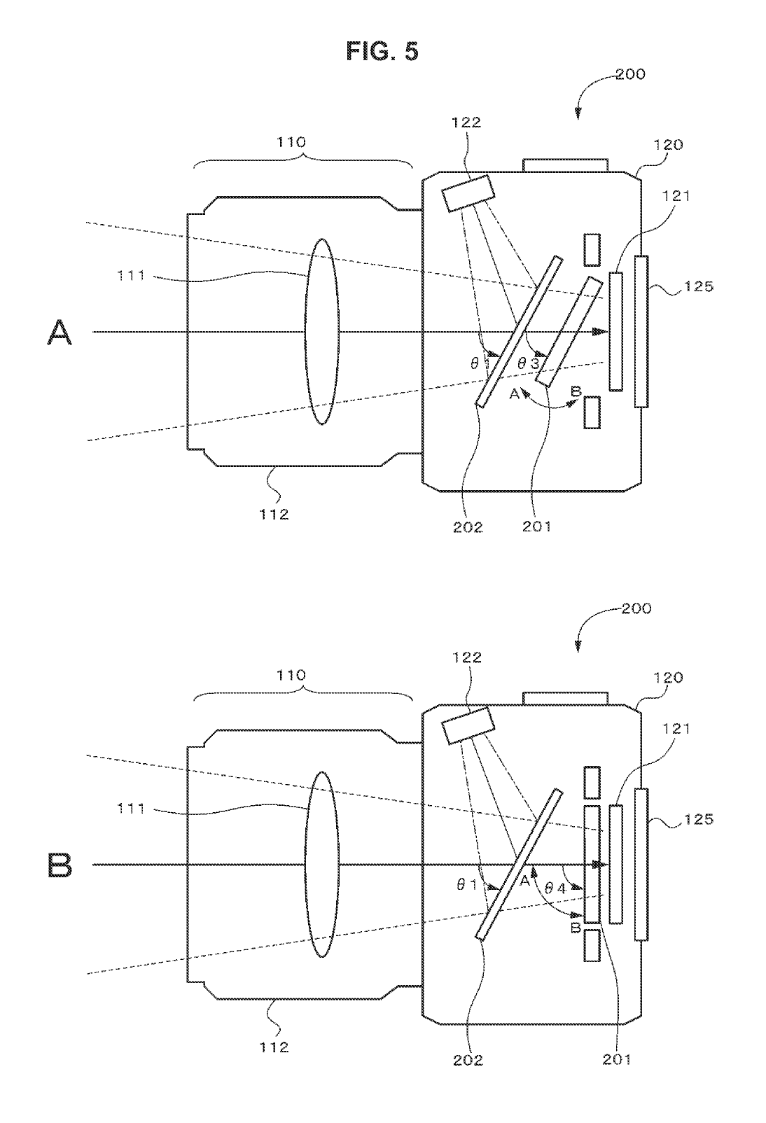

FIGS. 5A and 5B are schematic sectional views illustrating an overall configuration of an imaging device 200 according to the second embodiment of the present technology. The second embodiment is different from the first embodiment in that an optical filter 201 is configured to be rotatably driven in an AB direction so that an angle θ of the optical filter 201 with respect to an optical axis of a photographing lens 111 can be changed. The change in the angle θ by the driving of the optical filter 201 is performed, for example, when a driving mechanism that drives the optical filter 201 operates according to a user's input to the imaging device 200 under the control of a control unit or the like of the imaging device 200 controlling all or one of the units.

The optical filter 201 has different spectral transmittance characteristics between a case (hereinafter referred to as a third state) of “θ=θ3” illustrated in FIG. 5A and a case (hereinafter referred to as a fourth state) of “θ=θ4 (90°)” illustrated in FIG. 5B. Therefore, a film configuration in which the spectral transmittance characteristics are changed according to the angle with respect to the optical axis of the photographing lens 111 is assumed to be formed on the optical filter 201 by deposition and sputtering film formation or the like. The detailed spectral transmittance characteristics of the optical filter 201 will be described below. Further, the third and fourth states are assumed to satisfy a relation of “0<θ3<θ4) (90°.” More preferably, the third and fourth states are assumed to satisfy a relation of “45°<θ3<θ4 (90°).”

The second embodiment is different from the first embodiment in that the angle of a semi-transmissive film 202 with respect to the optical axis of the photographing lens 111 is not changed. However, the spectral transmittance characteristics of the semi-transmissive film 202 are different from those of the first embodiment. The spectral transmittance characteristics of the semi-transmissive film 202 will be described below. Since the other details are the same as those of the first embodiment, the description thereof will be omitted.

### 2-2. Operation and Advantage of Imaging Device

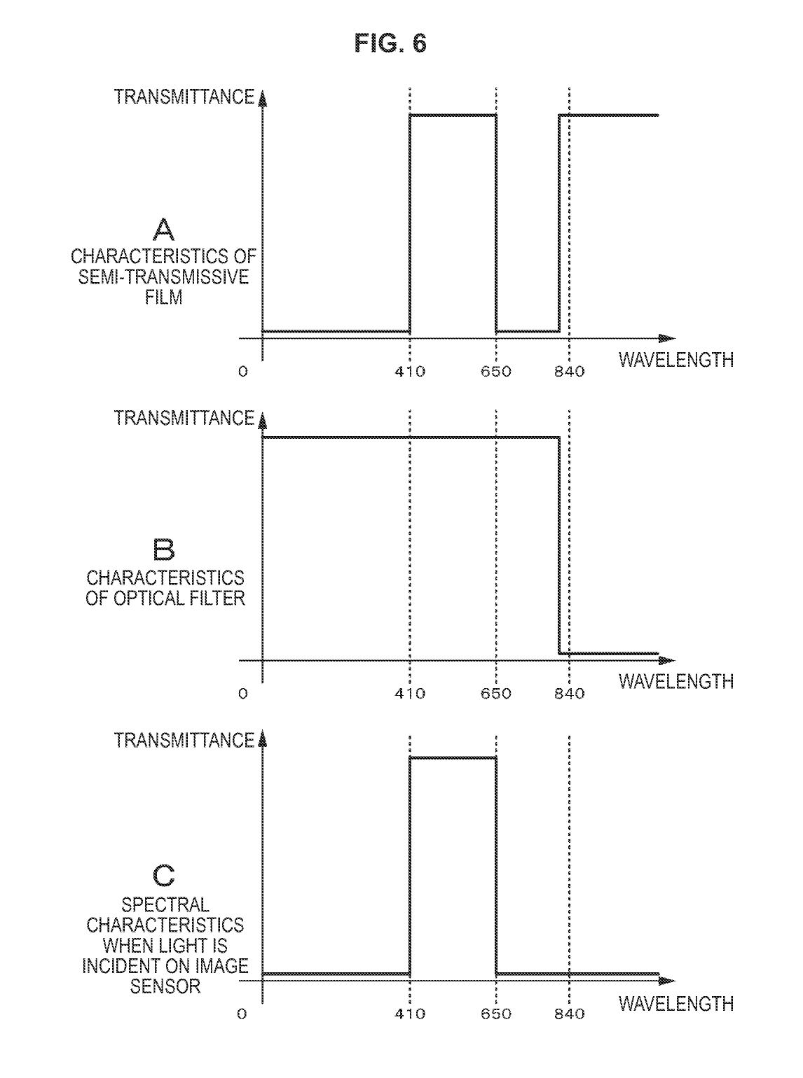

FIGS. 6A to 6C are diagrams illustrating spectral transmittance characteristics of the semi-transmissive film 202 and the optical filter 201 in the third state (θ=θ3) illustrated in FIG. 5A. The vertical axis represents transmittance and the horizontal axis represents a wavelength. The spectral transmittance characteristics of the semi-transmissive film 202 are shown in a form normalized according to the spectral transmittance characteristics of the optical filter 201.

FIG. 6A illustrates the spectral transmittance characteristics of the semi-transmissive film 202. According to the spectral transmittance characteristics of the semi-transmissive film 202, a band equal to or less than 410 nm is not transmitted, a band of 410 nm to 650 nm of the visible light is transmitted, a band of 650 nm to 830 nm is not transmitted, and a band equal to or greater than 830 nm is transmitted.

FIG. 6B illustrates the spectral transmittance characteristics of the optical filter 201. A cut wavelength of the optical filter 201 in the third state is 825 nm, a band equal to or less than 825 nm is transmitted, and a band equal to or greater than 825 nm is not transmitted.

FIG. 6C illustrates the spectral transmittance characteristics when the optical filter 201 in the third state and the semi-transmissive film 202 are combined. Since both the optical filter 201 and the semi-transmissive film 202 transmit the band of 410 nm to 650 nm of the visible light, the subject light of the band of 410 nm to 650 nm is incident on the image sensor 121.

On the other hand, the band equal to or greater than 825 nm which is the cut wavelength of the optical filter 201 is transmitted through the semi-transmissive film 202, but is not transmitted through the optical filter 201. Accordingly, the subject light of the band equal to or greater than 825 nm is not transmitted through the optical filter 201 and is thus not incident on the image sensor 121 when the semi-transmissive film 202 and the optical filter 201 are combined. Accordingly, as illustrated in FIG. 6C, only the band of 410 nm to 650 nm of the visible light is incident on the image sensor 121, and the other bands of the subject light are not incident on the image sensor 121. Thus, color reproduction can be easily designed, and thus an image with high quality can be photographed and generated.

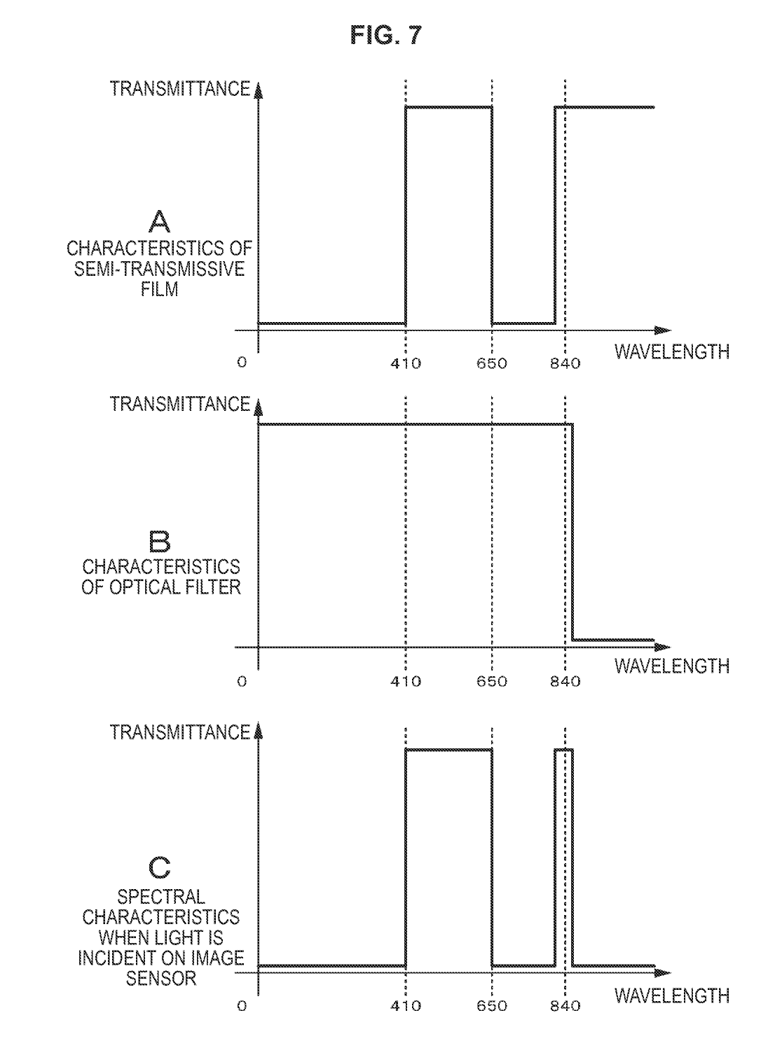

FIGS. 7A to 7C are diagrams illustrating spectral transmittance characteristics of the optical filter 201 and the semi-transmissive film 202 in the fourth state (θ=θ4 (90°)) illustrated in FIG. 5B. The vertical axis represents transmittance and the horizontal axis represents a wavelength. As described above, the relation of “θ3<θ4 (90°)” is assumed to be satisfied. More preferably, the relation of “45°<θ3<θ4 (90°)” is assumed to be satisfied.

FIG. 7A illustrates spectral transmittance characteristics of the semi-transmissive film 202. Since the semi-transmissive film 202 is not changed between the third and fourth states, the spectral transmittance characteristics are the same as those illustrated in FIG. 6A.

FIG. 7B illustrates the spectral transmittance characteristics of the optical filter 201. According to the spectral transmittance characteristics of the optical filter 201 in the fourth state, a cut wavelength is 850 nm, a band equal to or less than 850 nm is transmitted, and a band equal to or greater than 850 nm is not transmitted. Since the relation of “θ=θ4 (90°)” is satisfied, the incident angle of the subject light on the optical filter 201 is smaller, and thus a difference of a light path length in an optical thin film on the optical filter 201 is longer, compared to the third state. Therefore, the cut wavelength is shifted toward the long wavelength side. Thus, the optical filter 201 transmits the subject light of a band up to 850 nm.

FIG. 7C illustrates the spectral transmittance characteristics when the optical filter 201 in the fourth state and the semi-transmissive film 202 are combined. The band of 410 nm to 650 nm of the visible light is transmitted through both the semi-transmissive film 202 and the optical filter 201, and then is incident on the image sensor 121. This state is the same as the third state.

Since the cut wavelength of the optical filter 201 is also shifted up to 850 nm in the fourth state, the band equal to or less than 850 nm of the subject light is transmitted through the optical filter 201. On the other hand, since the semi-transmissive film 202 transmits the subject light of the range equal to or greater than 830 nm, as illustrated in FIG. 7C, the band of 830 nm to 850 nm is transmitted through the semi-transmissive film 202 and the optical filter 201, and then is incident on the image sensor 121.

That is, in the fourth state, not only the band of 410 nm 650 nm of the visible light but also the band of 830 nm to 850 nm in the subject light is transmitted through the image sensor 121. Accordingly, when a light-emitting element that emits infrared light of the band of 830 nm to 850 nm is used to perform photographing, nighttime photographing can be performed. This advantage is the same as the advantage of the first embodiment. That is, in the second embodiment, the relation between the semi-transmissive film and the optical filter in the first embodiment can be said to be reversed.

In the second embodiment, since the angle of the semi-transmissive film 202 with respect to the optical axis of the photographing lens 111 is not changed, the same advantage as that of the first embodiment can be obtained. Simultaneously, by causing the subject light to be incident also on the AF sensor 122, the AF sensor 122 can be used.

Even in the second embodiment, for example, the third state may be set to a normal photographing mode and the fourth state may be set to a nighttime photographing mode in the imaging device 100. Then, by rotatably driving the optical filter 201 according to a user's input of mode switching of the imaging device 100, the third and fourth states may be switched between.

### 3. Third Embodiment

### 3-1. Configuration of Imaging Device

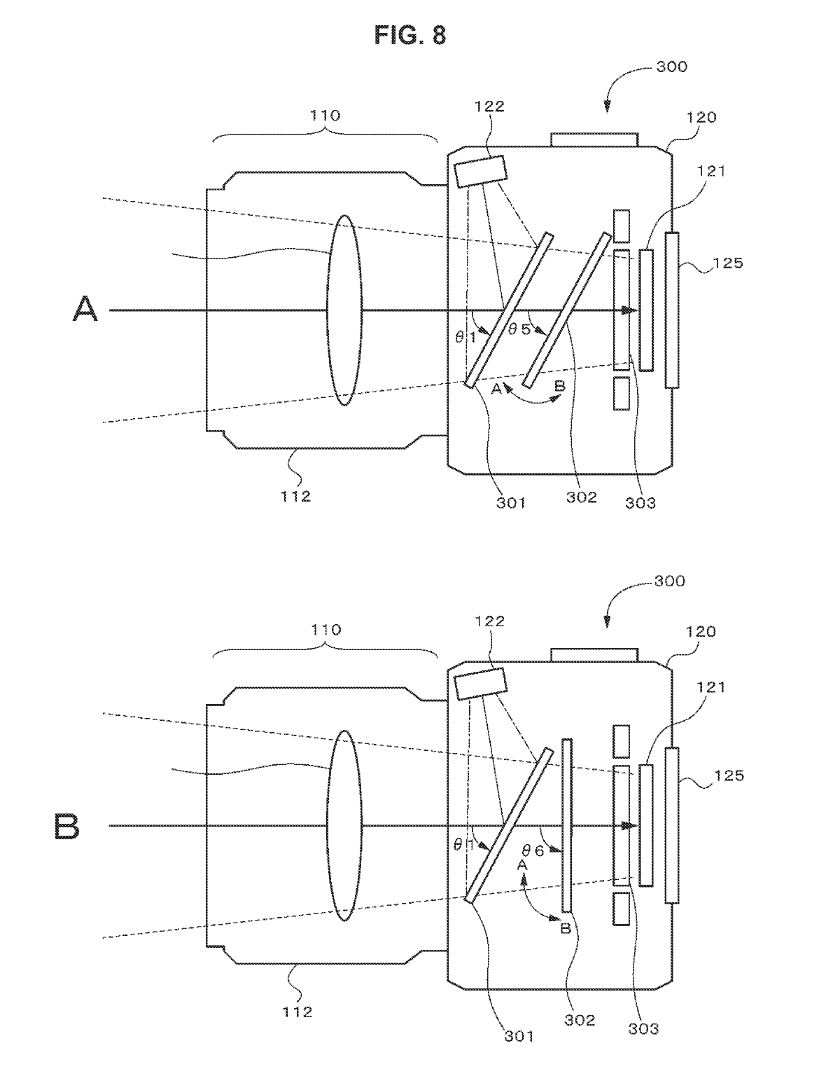

Next, a third embodiment of the present technology will be described. FIGS. 8A and 8B are schematic sectional views illustrating an overall configuration of an imaging device 300 according to the third embodiment of the present technology. The third embodiment is different from the first and second embodiments in that two semi-transmissive films are provided. Since the other details are the same as those of the first and second embodiments, the description thereof will be omitted.

In the third embodiment, a second semi-transmissive film 302 is disposed between a first semi-transmissive film 301 and an optical filter 303 inside the casing 120. The first semi-transmissive film 301 is the same as the semi-transmissive film of the second embodiment and is installed so that an angle θ with respect to the optical axis of a photographing lens 111 is fixed to θ1. The first semi-transmissive film 301 reflects a part of subject light incident via the photographing lens 111 toward an AF sensor 122 and transmits the remaining subject light toward the image sensor 121.

The second semi-transmissive film 302 is configured to be rotatably driven in an AB direction so that the angle θ with respect to the optical axis of the photographing lens 111 can be changed. The change in the angle θ by the driving of the semi-transmissive film 123 is performed, for example, when a driving mechanism that drives the second semi-transmissive film 302 operates according to a user's input to the imaging device 300 under the control of a control unit or the like of the imaging device 300 controlling all or one of the units.

The second semi-transmissive film 302 has different spectral transmittance characteristics between a case (hereinafter referred to as a fifth state) of “θ=θ5” illustrated in FIG. 8A and a case (hereinafter referred to as a sixth state) of “θ=θ6” illustrated in FIG. 8B. A film configuration in which the spectral transmittance characteristics are changed according to the angle with respect to the optical axis of the photographing lens 111 is assumed to be formed on the second semi-transmissive film 302 by deposition and sputtering film formation or the like. The detailed spectral transmittance characteristics of the second semi-transmissive film 302 will be described below. Further, θ5 and θ6 are assumed to satisfy a relation of “θ5<θ6.” More preferably, θ5 and θ6 are assumed to satisfy a relation of “θ5<θ6<90°.”

The optical filter 303 is disposed between the second semi-transmissive film 302 and the image sensor 121. The optical filter 303 is configured not to be driven as in the first embodiment. The spectral transmittance characteristics of the optical filter 303 will be described below. The imaging device 300 according to the third embodiment has the above-described configuration.

### 3-2. Operation and Advantage of Imaging Device

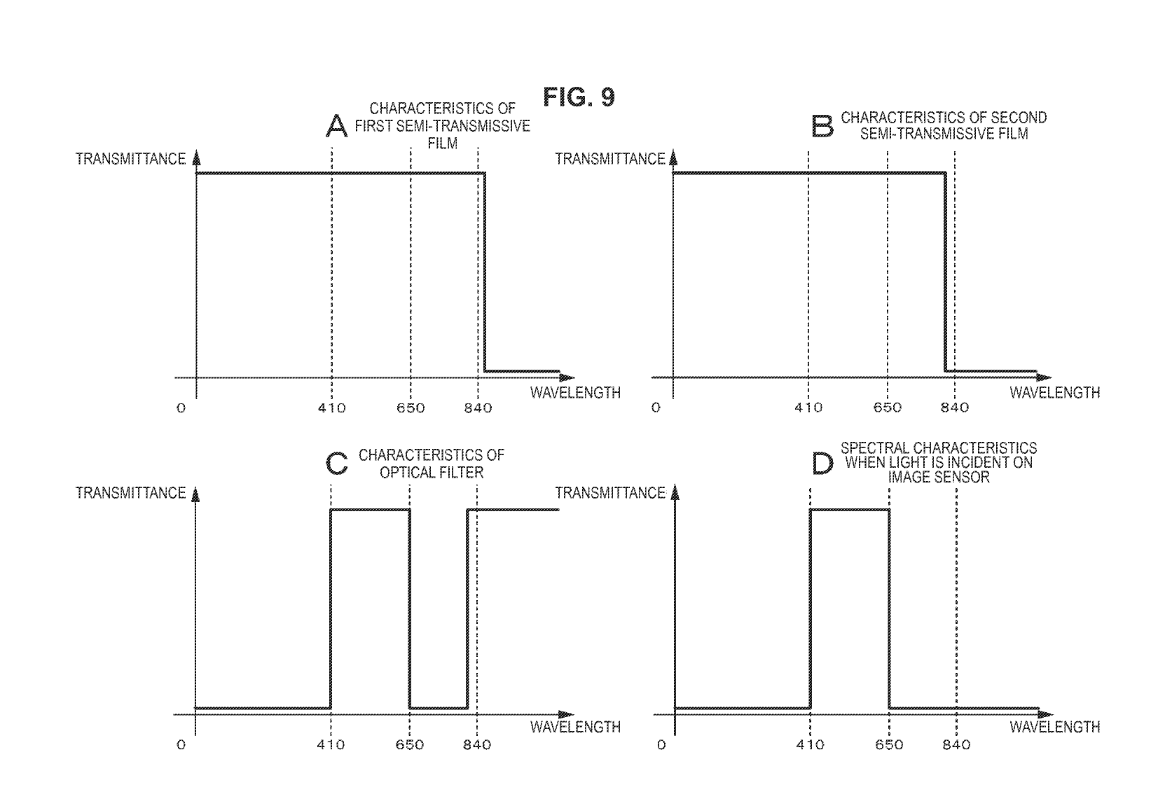

Next, an operation and an advantage of the imaging device 300 having the third configuration will be described. FIGS. 9A to 9D are diagrams illustrating spectral transmittance characteristics of the first semi-transmissive film 301, the second semi-transmissive film 302, and the optical filter 303 in the fifth state in which the angle of the second semi-transmissive film 302 is θ5, as illustrated in FIG. 8A. The vertical axis represents transmittance and the horizontal axis represents a wavelength. The spectral transmittance characteristics of the first semi-transmissive film 301 and the second semi-transmissive film 302 are shown in a form normalized according to the spectral transmittance characteristics of the optical filter 303.

FIG. 9A illustrates the spectral transmittance characteristics of the first semi-transmissive film 301. A cut wavelength of the first semi-transmissive film 301 is 850 nm, a band equal to or less than 850 nm is transmitted, and a band equal to or greater than 850 nm is not transmitted.

FIG. 9B illustrates the spectral transmittance characteristics of the fifth state (θ=θ5) of the second semi-transmissive film 302. A cut wavelength of the second semi-transmissive film 302 is 825 nm, a band equal to or less than 825 nm is transmitted, and a band equal to or greater than 825 nm is not transmitted.

FIG. 9C illustrates the spectral transmittance characteristics of the optical filter 303. According to the spectral transmittance characteristics of the optical filter 303, a band equal to or less than 410 nm is not transmitted, a band of 410 nm to 650 nm of the visible light is transmitted, a band of 650 nm to 830 nm is not transmitted, and a band equal to or greater than 830 nm is transmitted.

FIG. 9D illustrates the spectral transmittance characteristics when the first semi-transmissive film 301 in the fifth state, the second semi-transmissive film 302, and the optical filter 303 are combined. Since the first semi-transmissive film 301, the second semi-transmissive film 302, and the optical filter 303 transmit the band of 410 nm to 650 nm of the visible light, the subject light of the band of 410 nm to 650 nm is incident on the image sensor 121.

On the other hand, since the cut wavelength of the second semi-transmissive film 302 is 825 nm, the subject light of the band equal to or greater than 825 nm is not transmitted through the second semi-transmissive film 302 and is not incident on the image sensor 121. Accordingly, only the subject light in the range of 410 nm to 650 nm of the visible light is incident on the image sensor 121, and the other band of the subject light is not incident on the image sensor 121. Thus, color reproduction can be easily designed, and thus an image with high quality can be photographed and generated.

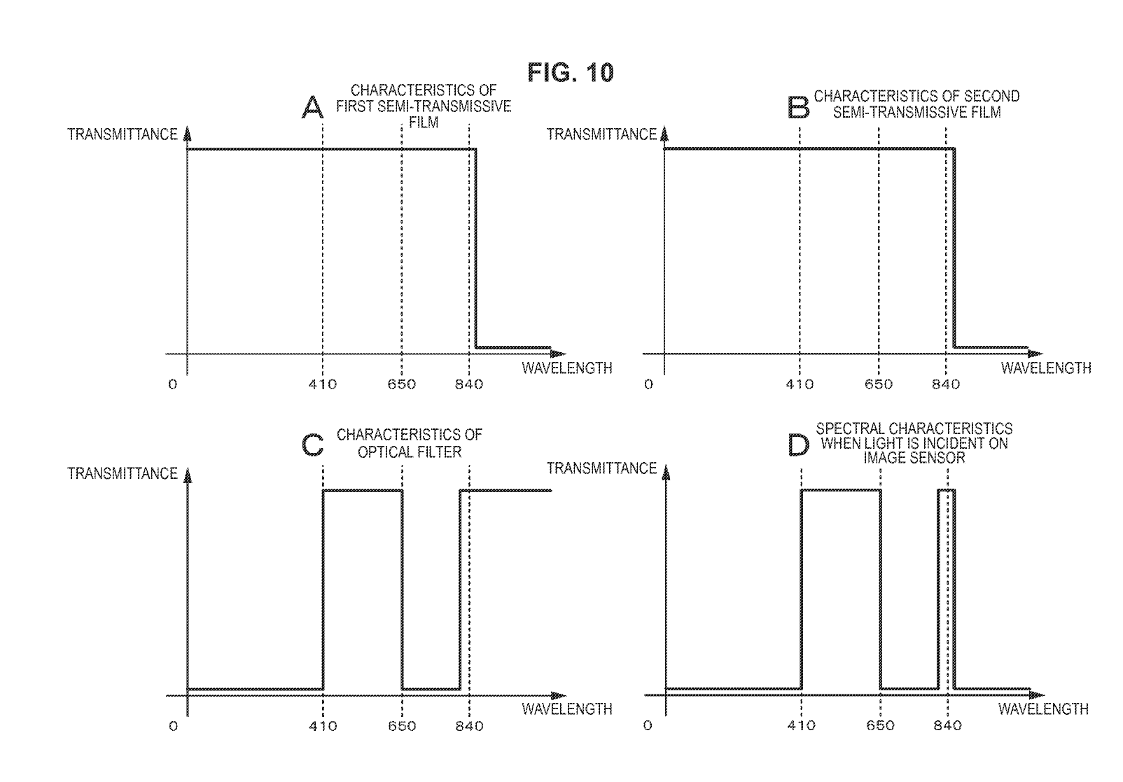

FIGS. 10A to 10D are diagrams illustrating spectral transmittance characteristics of the first semi-transmissive film 301, the second semi-transmissive film 302, and the optical filter 303 in the sixth state in which the angle θ of the second semi-transmissive film 302 with respect to the optical axis of the photographing lens 111 is θ6, as illustrated in FIG. 8B. As described above, θ5 and θ6 are assumed to satisfy the relation of “θ5<θ6.” More preferably, θ5 and θ6 are assumed to satisfy the relation of “θ5<θ6<90°.”

FIG. 10A illustrates spectral transmittance characteristics of the first semi-transmissive film 301. Since the first semi-transmissive film 301 is not changed between the fifth and sixth states, the spectral transmittance characteristics are the same as those illustrated in FIG. 9A.

FIG. 10B illustrates the spectral transmittance characteristics of the second semi-transmissive film 302. According to the spectral transmittance characteristics of the second semi-transmissive film 302 in the sixth state, the cut wavelength is 850 nm, a band equal to or less than 850 nm is transmitted and a band equal to or greater than 850 nm is not transmitted. Since the relation of “θ5<θ6” is satisfied, the incident angle of the subject light on the second semi-transmissive film 302 is smaller in a case of “θ=θ6,” and thus a difference of a light path length in an optical thin film on the second semi-transmissive film 302 is longer, compared to a case of “θ=θ5.” Therefore, the cut wavelength is shifted toward the long wavelength side. Thus, the second semi-transmissive film 302 transmits the subject light of the band equal to or less than 850 nm.

FIG. 10C illustrates spectral transmittance characteristics of the optical filter 303. The optical filter 303 is not changed between the fifth and sixth states, the spectral transmittance characteristics are the same as those illustrated in FIG. 9C.

FIG. 10D illustrates the spectral transmittance characteristics when the second semi-transmissive film 302 in the sixth state, the first semi-transmissive film 301, and the optical filter 303 are combined. The subject light of the band of 410 nm to 650 nm of the visible light is transmitted through all of the first semi-transmissive film 301, the second semi-transmissive film 302, and the optical filter 303, and then is incident on the image sensor 121. This state is the same as the fifth state.

Since the cut wavelength of the second semi-transmissive film 302 is shifted up to 850 nm in the sixth state, the second semi-transmissive film 302 transmits the subject light of the band equal to or less than 850 nm. The first semi-transmissive film 301 also transmits the subject light of the band equal to or less than 850 nm. Further, the optical filter 303 transmits the band equal to or greater than 830 nm. Thus, in the sixth state, the subject light of not only the band of 410 nm to 650 nm but also the band of 830 nm to 850 nm is transmitted through the first semi-transmissive film 301, the second semi-transmissive film 302, and the optical filter 303, as illustrated in FIG. 10D.

That is, in the sixth state, not only the band of 410 nm 650 nm of the visible light but also the light of the band of 830 nm to 850 nm is transmitted through the image sensor 121. Accordingly, as in the first embodiment, when a light-emitting element that emits infrared light of the band of 830 nm to 850 nm is used to perform photographing, nighttime photographing can be performed.

In the third embodiment, the same advantage as that of the first embodiment can be obtained and the subject light can be incident even on the AF sensor 122. Further, it is not necessary to drive the optical filter 303. Therefore, for example, even when the image sensor 121 and the optical filter 303 are packaged and the optical filter 303 may not be driven, the embodiment of the present technology is applicable.

Even in the third embodiment, for example, the fifth state may be set to a normal photographing mode and the sixth state may be set to a nighttime photographing mode in the imaging device 100. Then, by rotatably driving the second semi-transmissive film 302 according to a user's input of mode switching of the imaging device 100, the fifth and sixth states may be switched.

The value of the wavelength used in the description of the embodiments of the present technology has been suggested as one example. The embodiments of the present technology are not limited to the value.

### 4. Modification Example

The detailed embodiments of the present technology have been described above. However, the present technology is not limited to the above-described embodiments, and may be modified in various ways based on the technical spirit and essence of the present technology. The present technology can also include the following configurations.

(1) An imaging device including:

an image sensor that performs photoelectric conversion on subject light to generate an image signal;

a photographing optical system that forms an image of the subject light on the image sensor; and

a first optical member that transmits the subject light incident on the image sensor via the photographing optical system,

wherein the first optical member changes transmittance of a first band of the subject light according to an angle with respect to an optical axis of the photographing optical system.

(2) The imaging device according to (1), wherein the first optical member changes the transmittance of the first band of the subject light incident on the image sensor is changed by switching the angle with respect to the optical axis of the photographing optical system from a first angle to a second angle.
(3) The imaging device according to (2), wherein the first optical member increases the transmittance of the first band of the subject light incident on the image sensor by switching the angle with respect to the optical axis of the photographing optical system from the first angle to a second angle greater than the first angle.
(4) The imaging device according to any one of (1) to (3), wherein the first optical member transmits a second band of the subject light, irrespective of the angle with respect to the optical axis of the photographing optical system.
(5) The imaging device according to any one of (1) to (4), further including:

a second optical member that is disposed between the image sensor and the first optical member and transmits the first band of the subject light.

(6) The imaging device according to (5), wherein the second optical member further transmits the second band of the subject light.
(7) The imaging device according to (6), wherein the second optical member does not transmit a third band between the first band and the second band of the subject light.
(8) The imaging device according to any one of (1) to (7), wherein the first band is a band of infrared light.
(9) The imaging device according to any one of (1) to (8), wherein the second band is a band of visible light.
(10) An imaging method performed by an imaging device including an image sensor that performs photoelectric conversion on subject light to generate an image signal, a photographing optical system that forms an image of the subject light on the image sensor, and a first optical member that transmits the subject light incident on the image sensor via the photographing optical system, the method including:

changing transmittance of a first band of the subject light in the first optical member by changing an angle of the first optical member with respect to an optical axis of the subject light.

The present disclosure contains subject matter related to that disclosed in Japanese Priority Patent Application JP 2012-123941 filed in the Japan Patent Office on May 31, 2012, the entire content of which is hereby incorporated by reference.

What is claimed is:

1. An imaging device comprising:
an image sensor that performs photoelectric conversion on subject light to generate an image signal;
a photographing optical system that forms an image of the subject light on the image sensor; and
a first optical member that transmits the subject light incident on the image sensor via the photographing optical system,
wherein the first optical member changes transmittance of a first band of the subject light according to an angle with respect to an optical axis of the photographing optical system.

2. The imaging device according to claim 1, wherein the first optical member changes the transmittance of the first band of the subject light incident on the image sensor via the photographing optical system is changed by switching the angle with respect to the optical axis of the photographing optical system from a first angle to a second angle.

3. The imaging device according to claim 2, wherein the first optical member increases the transmittance of the first band of the subject light incident on the image sensor via the photographing optical system by switching the angle with respect to the optical axis of the photographing optical system from the first angle to a second angle greater than the first angle.

4. The imaging device according to claim 1, wherein the first optical member transmits a second band of the subject light, irrespective of the angle with respect to the optical axis of the photographing optical system.

5. The imaging device according to claim 1, further comprising:
a second optical member that is disposed between the image sensor and the first optical member and transmits the first band of the subject light.

6. The imaging device according to claim 5, wherein the second optical member further transmits the second band of the subject light.

7. The imaging device according to claim 6, wherein the second optical member does not transmit a third band between the first band and the second band of the subject light.

8. The imaging device according to claim 1, wherein the first band is a band of infrared light.

9. The imaging device according to claim 4, wherein the second band is a band of visible light.

10. An imaging method performed by an imaging device including an image sensor that performs photoelectric conversion on subject light to generate an image signal, a photographing optical system that forms an image of the subject light on the image sensor, and a first optical member that transmits the subject light incident on the image sensor via the photographing optical system, the method comprising:
changing transmittance of a first band of the subject light in the first optical member by changing an angle of the first optical member with respect to an optical axis of the subject light.
